(19) United States
(12) Patent Application Publication
(10) Pub. No.: US 2015/0143390 A1
(43) Pub. Date: May 21, 2015

(54) FILLABLE FORM FOR PROVIDING AND RECEIVING CUSTOMIZED AUDIO VIDEO CONTENT

(71) Applicant: SONY CORPORATION, Tokyo (JP)

(72) Inventor: Luke Vernor Fay, San Diego, CA (US)

(73) Assignee: SONY CORPORATION, Tokyo (JP)

(21) Appl. No.: 14/086,449

(22) Filed: Nov. 21, 2013

(51) Int. Cl. H04N 21/2668; H04N 21/414; H04N 21/41; G06Q 30/02; H04N 21/658; H04N 21/258; H04N 21/45; H04N 21/81; H04N 21/442

(52) U.S. Cl. CPC H04N 21/2668; H04N 21/8126; H04N 21/812; H04N 21/41407; H04N 21/4126; H04N 21/44231; H04N 21/658; H04N 21/25891; H04N 21/25883; H04N 21/4532; H04N 21/4524; G06Q 30/0269; G06Q 30/0261
USPC 725/9

(57) ABSTRACT

A consumer electronics (CE) device receives a form along with AV content that includes information fields pertaining for entrance of information regarding the CE device and/or at least one user thereof. Information entered to the form is then transmitted back to the provider of the form for use to subsequently provide to the CE device advertisements, notifications of device and/or software updates, and other AV content targeted to the CE device and/or its user based on the information entered to the form.

### FIELD OF THE INVENTION

The present application relates generally to using metadata to customize content provided on a consumer electronics (CE) device.

### BACKGROUND OF THE INVENTION

The advancing technology and growing popularity of consumer electronics (CE) devices has promoted an increase in advertising potential and provided another avenue by which companies can market their products and/or services to customers. Customers are more exposed to advertising through frequent use of portable CE devices, such as smartphones, throughout the day. An increased demand and dependency on CE devices correlates to increased potential for companies to advertise.

The majority of current advertising is generally provided to large sets of people and fails to adequately target particular customers at a personal level. Information gathering regarding likes and dislikes of customers carried out by websites, TV broadcasters, newspapers, magazines, etc. is performed at a very broad level. Thus, although the scope of the overall advertising may be directed to a large target audience, only a portion of the advertising suits each individual of that audience group.

### SUMMARY OF THE INVENTION

Accordingly, present principles recognize that knowledge of the habits, personal interests, etc. of individual audience members enables advertising strategies to be more effective. Present principles further recognize that a form containing information pertaining to specifics of a consumer electronics (CE) device and associated user can be provided along with AV content. The form may include multiple fields such as, but not limited to, location, user hobbies, user likes and dislikes, etc. The information carried on the form may be used to provide targeted user-specific advertising or other content onto the CE device or networked CE devices. The form may be made available to the content source and stored on a cloud storage area or sent directly to the content source.

Accordingly, in a first aspect a device includes at least one computer readable storage medium that is not a carrier wave and that bears instructions executable by a processor and at least one processor configured for accessing the computer readable storage medium to execute the instructions. Execution of the instructions configures the processor for reception of an audio video (AV) content stream from a content source and reception of a form with the AV content stream. The form includes plural information fields, which in turn include at least an available devices field and a location field. Execution of the instructions also configures the processor for inserting information pertaining to plural networked devices in the available devices field and inserting at least a location of the networked devices into the location field. Execution of the instructions further configures the processor for making the form with the inserted information accessible to the content source.

The device can be a consumer electronics (CE) device and at least a first networked device of the networked devices can be the CE device. The information pertaining to a second networked device of the networked devices may be inserted into the available devices field. Furthermore, the second networked device information can be determined by the first networked device based on information pertaining to the second networked device gathered by the first networked device using universal plug and play (UPnP) communication (and/or e.g. Wi-Fi, etc.). The location of the networked devices can be a zip code encompassing the networked devices.

The form may be made accessible to the content source either by storing the form with the inserted information in a cloud storage area accessible to the content source or by transmitting the form with the inserted information to the content source. The form information may be automatically inserted without user input into the plural information fields in response to reception of the form.

The form may also include a profile field configured for insertion of profile information pertaining to a user of the device. The instructions can configure the processor for inserting the profile information into the profile field. The device may access social networking account information belonging to the user and can use that information to complete profile information fields. The device may also access information pertaining to the user's AV content observance history and can include that information in the profile information. Furthermore, demographic information pertaining to the user may be determined by the device based on an AV content history of AV content presented on the device and can be included in the profile information.

The form may further include a likes and dislikes field configured for insertion of information pertaining to AV content likes and dislikes of a device user. Execution of instructions stored on the storage medium may configure the processor for insertion of information pertaining to AV content likes and dislikes of the user, which can be determined based on user input received by the device of respective likes and dislikes of AV contents.

In another aspect, a server includes at least one computer readable storage medium bearing instructions executable by a processor and at least one processor configured for accessing the computer readable storage medium to execute the instructions. Execution of the instructions configure the processor for providing an instrument to a first consumer electronics (CE) device configured for entrance of data by the first CE device. That instrument includes at least one area in which data is enterable by a CE device. The at least one area in turn includes an area configured for entrance of data pertaining to device identification information for at least one CE device. Execution of instructions also configures the processor for reception of the instrument back from the first CE device with device identification information included in the instrument for the at least one CE device. The device identification information is entered at the first CE device. The instructions further configure the processor to, in response to a determination that the device identification information pertains to a CE device for which an update is available, provide a notification to the first CE device that the update is available.

In another aspect, a method includes providing a first audio video (AV) content to at least a first consumer electronics (CE) device along with a metadata tag for the first AV content. The metadata tag includes location information for a form accessible by the first CE device. The form is configured for entrance of data by the first CE device. The method also includes accessing data entered by the first CE device to the form and providing a second AV content to the first CE device at least in part based on the data.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example CE device in accordance with present principles;

FIG. 2 is an example flowchart of logic to be executed by a CE device for receiving content along with a field-fillable form, completing the form, and sending the form back to the provider of the form in accordance with present principles;

FIG. 3 is an example flowchart of logic to be executed by a server for providing forms, AV content, and/or notifications in accordance with present principles;

FIG. 4 is an example visual representation of a form in accordance with present principles that is manipulable by a user;

FIG. 5 is an example update notification presentable on a CE device in accordance with present principles; and

FIG. 6 is an example settings user interface (UI) presentable on a CE device for configuring e.g. form fields and/or automatic form information input in accordance with present principles.

### DETAILED DESCRIPTION OF THE PREFERRED EMBODIMENT

This disclosure relates generally to consumer electronics (CE) device based user information. With respect to any computer systems discussed herein, a system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software modules described by way of flow charts and/or user interfaces herein can include various sub-routines, procedures, etc. It is to be understood that logic divulged as being executed by a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

In an example, a processor can access information over its input lines from data storage, such as the computer readable storage medium, and/or the processor accesses information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the CE device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

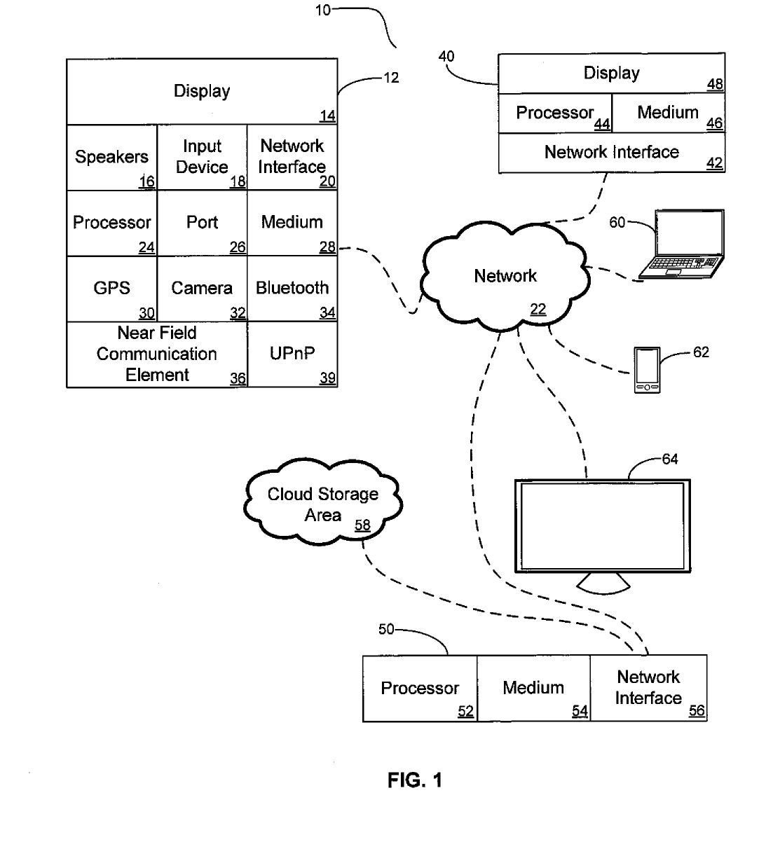

Before describing FIG. 1, it is to be understood that the CE devices and software described herein are understood to be usable in the context of a digital ecosystem. Thus, as understood herein, a computer ecosystem, or digital ecosystem, may be an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony Electronics. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are associated with the same company (e.g. produced by the same manufacturer), and are specifically designed to seamlessly interact with one another. Horizontal ecosystems, one the other hand, integrate aspects such as hardware and software that are created by differing entities into one unified ecosystem. The horizontal approach allows for greater variety of input from consumers and manufactures, increasing the capacity for novel innovations and adaptations to changing demands. But regardless, it is to be understood that some digital ecosystems, including those referenced herein, may embody characteristics of both the horizontal and vertical ecosystems described above.

Now specifically referring to FIG. 1, an example system 10 is shown, which may include one or more of the example devices disclosed herein. The first of the example devices included in the system 10 is an example consumer electronics (CE) device 12, such as a computerized Internet-enabled (e.g. “smart”) television (TV). Regardless, it is to be understood that the CE device 12 is configured to undertake present principles (e.g. communicate with other CE devices to undertake present principles, execute the logic described herein, and perform any other functions and/or operations described herein).

Accordingly, to undertake such principles the CE device 12 can include some or all of the components and/or elements shown in FIG. 1. For example, the CE device 12 can include one or more touch-enabled displays 14, one or more speakers 16 for outputting audio in accordance with present principles, and at least one additional input device 18 such as e.g. an audio receiver/microphone for e.g. entering audible commands to the CE device 12 to control the CE device 12. The example CE device 12 may also include one or more network interfaces 20 for communication over at least one network 22 such as the Internet, an WAN, an LAN, etc. under control of one or more processors 24. It is to be understood that the processor 24 controls the CE device 12 to undertake present principles, including the other elements of the CE device 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, WiFi transceiver, etc.

In addition to the foregoing, the CE device 12 may also include one or more input ports 26 such as, e.g., a USB port to physically connect (e.g. using a wired connection) to another CE device and/or a headphone port to connect headphones to the CE device 12 for presentation of audio from the CE device 12 to a user through the headphones. The CE device 12 may further include one or more tangible computer readable storage medium 28 such as disk-based or solid state storage, it being understood that the computer readable storage medium 28 may not be a carrier wave. Also in some embodiments, the CE device 12 can include a position or location receiver such as but not limited to a GPS receiver and/or altimeter 30 that is configured to e.g. receive geographic position information from at least one satellite and provide the information to the processor 24 and/or determine an altitude at which the CE device 12 is disposed in conjunction with the processor 24. However, it is to be understood that that another suitable position receiver other than a GPS receiver and/or altimeter may be used in accordance with present principles to e.g. determine the location of the CE device 12 in e.g. all three dimensions.

Continuing the description of the CE device 12, in some embodiments the CE device 12 may include one or more cameras 32 that may be, e.g., a thermal imaging camera, a digital camera such as a webcam, and/or a camera integrated into the CE device 12 and controllable by the processor 24 to gather pictures/images and/or video in accordance with present principles (e.g. to (1) gather an image of a user for executing facial recognition software on the image to thus determine the user, and (2) determine a mood, and/or like or dislike, of a user). Also included on the CE device 12 may be a Bluetooth transceiver 34 and other Near Field Communication (NFC) element 36 for communication with other devices using Bluetooth and/or NFC technology, respectively. An example NFC element can be a radio frequency identification (RFID) element.

Using a universal plug and play (UPnP) communication element 39, the first CE device 12 may communicate and exchange information over the network 22 with a second networked device 40, such as, but not limited to a set-top box using UPnP communication, though it is to be understood that such communication may additionally or alternatively occur through the network interface 20. In any case, it is to be understood that networked device information for a second networked device 40 can be determined by the CE device 12 based on information pertaining to the second networked device 40 gathered by the CE device 12 using UPnP communication and/or protocols.

In addition to the foregoing, it is to be understood that the location of the networked devices 12, 40 as determined using data from respective GPS receivers and applying the data to e.g. a map of zip codes or a data table of zip codes to thus determine a zip code encompassing the networked devices corresponding to the GPS coordinates that were used to determine the zip code. Describing the CE device 40 even further, note that it may include some or all of the components and/or elements described in reference to the CE device 12, such as but not limited to a network interface (I/F) 42 to communication over the network 22 under the direction of a processor 44 that can execute instructions stored on a storage medium 46. Further, the processor 44 may execute instructions stored on medium 46 in accordance with present principles to present media on a display 48 of the second networked device 40, input information into the form described herein, etc.

The CE devices 12 and 40 may also communicate and exchange information with a server 50. The server 50 operates under the control of a server processor 52 that executes instructions stored on a server storage medium 54. A server network interface (I/F) 56 may also be included in the server. Note that the network interface 56 may be, e.g., a wired or wireless modem or router, WiFi transceiver, or other appropriate interface such as, e.g., a wireless telephony transceiver. The server 50 may provide a form, data sheet, questionnaire, log, register, and/or instrument to the CE devices 12 and 40 in accordance with present principles, where the form may be configured for entrance of data by the CE devices 12 and 40 as described further below. Briefly, it is to be understood that the form and/or instrument can include at least one area or field, pertaining to device identification, in which data is enterable by the CE device 12 and/or 40.

In any case, it is to be further understood that the server 50 may be an audio/video (AV) content provider (or otherwise associated therewith) and provide AV content to the CE device 12 directly or indirectly. As alluded to above, the server 50 may provide a field-fillable form that may be completed (e.g. auto-filled) or otherwise have data entered thereto by the CE devices 12 and/or 40, and/or manually entered by the user of the CE devices 12 and/or 40. The completed form may then be sent back and received by the server 50, though it is to be understood that in addition to or in lieu of that, it may be stored in a cloud storage area 58 (that need not necessarily be at the server 50) accessible to both the devices 12, 40 and the server 50 via the network 22. Accordingly, the server 50 may facilitate data exchange between CE device devices in accordance with present principles, and may include and perform “cloud” functions such that the CE devices of the system 10 may access a “cloud” environment via the server 50 in example embodiments to e.g. access and complete a fillable form, and/or access a tag indicating another location of form that is accessible to the CE devices of the system 10.

Additionally, it is to be understood that still other CE devices may be part of the system 10, such as an Internet-enabled laptop computer 60, an Internet-enabled smartphone 62, and/or an Internet-enabled tablet computer 64. It is to be understood that these other CE devices 60, 62, and 64 and still others that may be used in accordance with present principles may respectively include some or all of the various components described above in reference to the CE device 12 such but not limited to e.g. a network I/F, a camera, a touch-enabled display, speakers, a processor, and a storage medium etc. Also note that all of the devices described in reference to FIG. 1, including the server 50, may communicate with each other over the network 22 using a respective network interface included thereon, and may each also include a computer readable storage medium that may not be a carrier wave for storing logic and/or software code in accordance with present principles to be executed at least by their respective processors.

Though not shown, it is to be understood that the system 10 may also include a head end associated with a content provider that is configured to provide content such as audio video (AV) content to the CE devices 12, 40, 60, etc. In such embodiments the head end may be e.g. a cable head end and/or a satellite head end. Furthermore, the head end is understood to be in communication with the CE devices 12, 40, 60, sever 50, etc. over, e.g., a closed network (through a wired or wireless connection), and furthermore may itself include a network interface (not shown) such that the head end may communicate with the CE devices 12, 40 and/or server 50 over a wide-area and/or open network such as the network 22. Further still, it is to be understood that the head end may be wired or wirelessly connected to a non-internet server, and/or may optionally be integrated with a non-internet server and/or the server 50.

In any case, it is to be understood that the head end may facilitate the transmission of information and AV content to the CE devices of the system 10 through e.g. respective set top boxes associated with the CE devices. It is to be understood that such set top boxes, and/or the CE devices themselves, may e.g. locally store (on a computer readable storage medium for the respective device) a channel and/or content presentation history of AV content that has been selected for presentation on the respective CE device under control of a set top box processor (also not shown). Notwithstanding, it is to be understood that e.g. the sever 50 and head end may also store channel and/or program history information in accordance with present principles (e.g. for entering such information into a form in accordance with present principles).

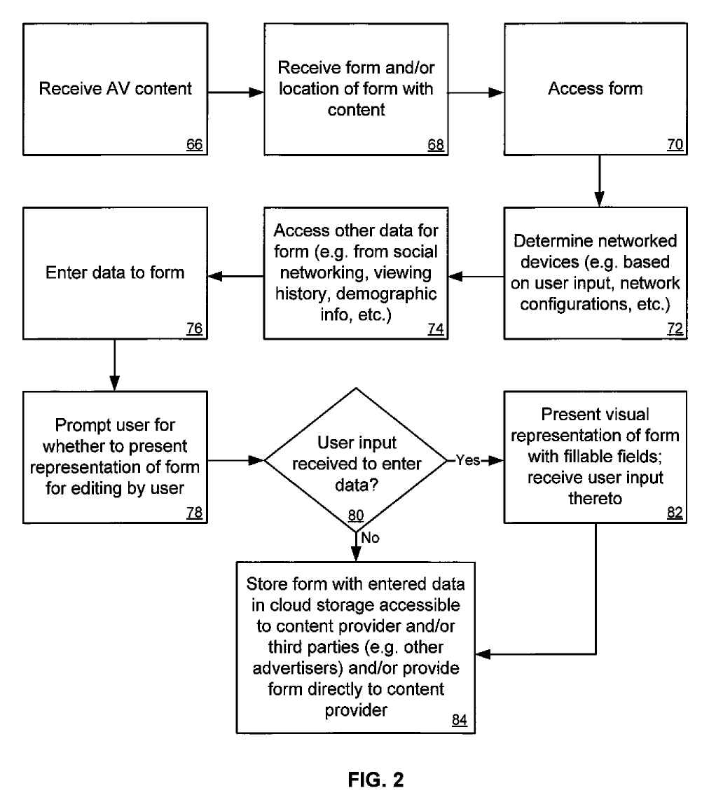

Turning now to FIG. 2, an example flowchart of logic to be executed by a CE device such as the CE device 12 in accordance with present principles for the reception of content by the CE device along with a form and/or tag indicating the location of the form for access by the CE device. The logic begins with the CE device receiving AV content at block 66 and receiving a form and or location of the form (e.g. separately from the content, though it is to be understood that it may also be received with the content) as indicated in e.g. a tag (e.g. included in a component of AV content such as the audio or video). The CE device may access the form at block 70 under the direction of the CE device processor (and/or e.g. parse the form to determine data and/or information that should be entered to various portions thereof) and may, at block 72, determine whether any networked devices such as a laptop or smartphone are present based on e.g. UPnP communications therebetween (and/or e.g. Wi-Fi network information and communications, or still other types of information gathering procedures for determining e.g. device ID and/or device description (e.g. Blueray player, TV, phone, etc.), etc.), as well as user input, network configurations, etc.

The CE device may also access and/or determine other data for the form at block 74, such as e.g. profile information for a user of the CE device executing the logic of FIG. 2 (e.g. social networking information and/or profiles, viewing history, demographic information, etc. as described herein). Then at block 76 the logic enters the data and/or information into (e.g. the appropriate fields of) the form at block 76 and then at block 78 may provide a prompt to the user (e.g. on a display of the CE device) for whether the CE device is to present a representation of the form for editing of the information and data entered thereto by the user (e.g. based on selection of a yes selector element to edit the form or no selector element to not edit the form that are both included on the prompt). The user of the CE device 12 may provide input responsive to the prompt, where determining whether such input has been received occurs at decision diamond 80. Based on determining that such input was received, the logic proceeds to block 82, where the logic may present the form and/or a visual representation thereof on the CE device for editing and/or completion by the user. The form with data and/or information entered thereto may then be stored at block 84 e.g. in cloud storage accessible to content provider and third parties, e.g. advertisers, and/or may be provided by the CE device to the device or provider from which the form was provided as received at block 66 (e.g. a content provider server). Referring back to diamond 80, note that if it is determined that no input has been received responsive to the prompt for the user to edit the form, the logic may instead proceed directly to block 84.

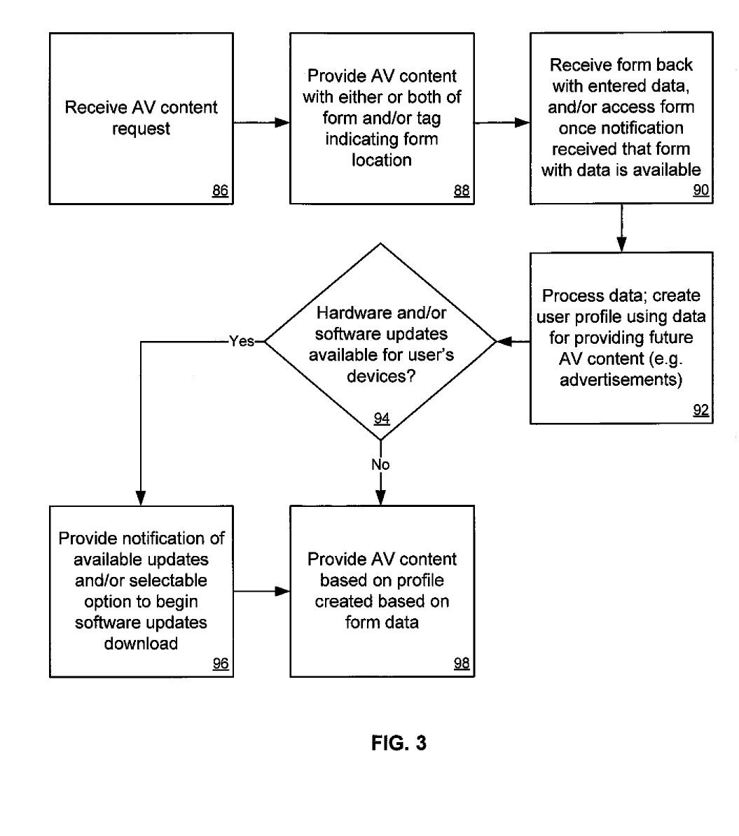

Continuing now in reference to FIG. 3 an example flowchart of logic to be executed by a content provider and/or server in accordance with present principles is shown. Beginning with block 86, the logic receives an AV content request from a CE device such as the CE device 12 described above. Then at block 88 the logic provides the requested AV content with either or both of the form described herein and/or a tag or other indication indicating the location of the form for the CE device to access the form at the location for providing data and/or information thereto. The logic then continues on to block 90 where the logic receives back the form (and/or otherwise accesses the form after receiving a notification that a CE device has entered at least some data and/or information thereto) with data and/or information from the CE device entered thereto.

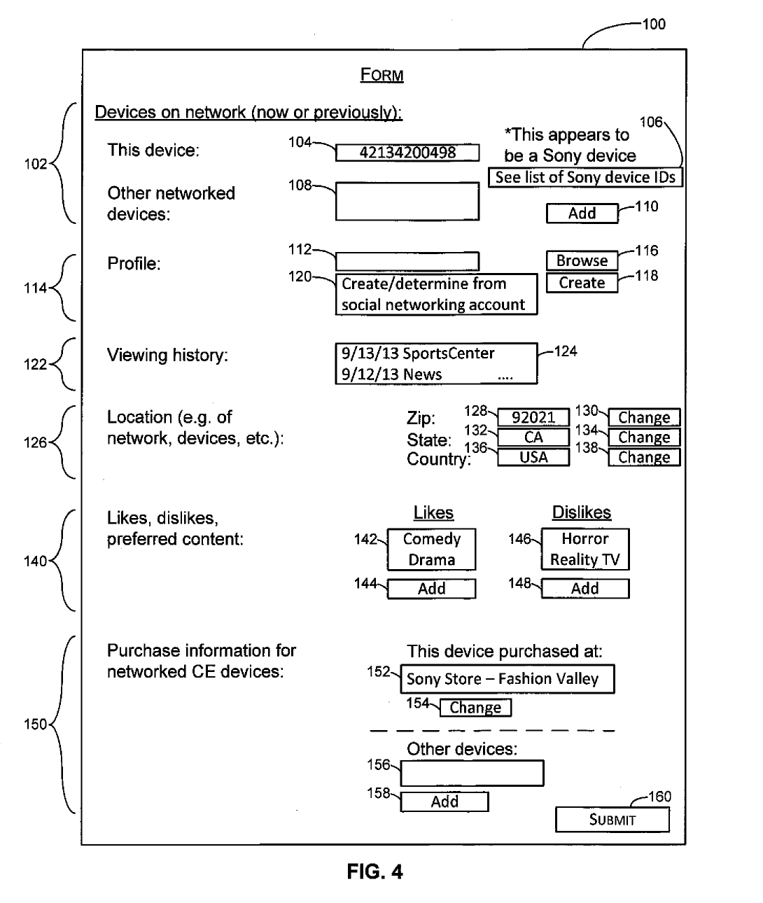

From block 90 the logic of FIG. 3 moves to block 92 where the logic processes or otherwise accesses the data entered to the form and may even e.g. create a user profile based on the data and/or information for use when determining e.g. AV content to later recommend to the user and/or when determining a particular advertisement to provide to the user via the user's CE device. From there the logic moves to decision diamond 94 where the logic determines based on e.g. device information entered to the form by the CE device that completed the form, whether hardware and/or software updates for one or more devices indicated in the device information are available. Based on a determination that at least one such update is available, the logic proceeds to block 96 where the logic provides a notification to the CE device (that entered the data to the form and/or the CE device(s) for which the update(s) is available) that the updates are available. Also at block 96 the logic may provide in the notification e.g. a selector element selectable by the user via the CE device to automatically without further user input responsive thereto initiate e.g. a download of a software update to the CE device for which the update is available. The logic then proceeds to block 98 where the logic provides other AV content and/or advertisements to the user via the CE device based on at least one portion of the data and/or information from the form. Last before moving on to FIG. 4, note that should the logic at diamond 94 determine that no such update as described above is available, the logic may proceed directly to block 98.

Now in reference to FIG. 4, an exemplary visual representation of a form 100 provided to a CE device (referred to in reference to FIG. 4 as the “present CE device”) e.g. in metadata included with AV content being provided to the present CE device in accordance with present principles is shown. The form includes a first portion 102 for which device information may be entered. A first device field 104 is shown for entry of CE device information (e.g. a device identification (ID) and/or manufacturer ID for the device, and/or an IP address for the device) for the CE device to which the form was provided and/or the present CE device presenting the form 100. Note that next to the field 104 is an indication that the device appears to be a Sony Electronics device, which may be presented responsive to a determination by a server in communication with the device and/or the device itself that the device is a Sony Electronics product. Also note that adjacent to the field 104 is a selector element 106 selectable to e.g. automatically without further user input responsive thereto present a listing of e.g. particular CE devices and their respective device ID and/or IP addresses for selection of at least one CE device and/or information from the list to thus be entered in the field 104 if information e.g. automatically entered into the field 104 as shown by the CE device prior to receiving user input is incorrect or the user nonetheless wishes to change it.

The portion 102 also includes a field 108 for entry of CE device information (e.g. a device identification (ID) and/or manufacturer ID for the device, and/or an IP address for the device) for one or more other CE devices e.g. in communication with the present CE device (e.g. via UPnP) or for which the user desires to enter information even if not e.g. presently communicating over the network of CE devices (e.g. a home Wi-Fi network). Note that next to the field 108 is an add selector element 110 that is selectable to e.g. automatically without further user input responsive thereto insert additional fields and/or data entry fields beneath the field 108 but above a profile field 112 to be described shortly to thus include separate fields for each additional CE device for which the user desires to enter information. Note further that in some embodiments and in addition to or in lieu of adding a device field, the element 110 may also be selected to e.g. cause a window to be overlaid on the form 100 for manipulation to delete one or more of the fields for additional CE device and/or delete any data and/or information entered thereto. Furthermore, note that a selector element similar in function and configuration to the element 106 may be presented adjacent to and associated with the field 108 for similarly selecting e.g. a device ID from a list to be entered in the field 108.

As indicated above, the form 100 may also include a profile field 112 as part of e.g. a profile portion 114 of the form 100. The profile field may be configured for e.g. entrance of data and/or information by a user for which the user desires to be included in a profile for the user to be created by e.g. the provider of the form received by the present CE device. In addition to or in lieu of the foregoing, a preconfigured user profile e.g. locally stored on a storage medium of the present CE device or e.g. in a cloud storage area accessible to the CE device may be browsed to and subsequently selected e.g. at least in part based on selection of the browse selector element 116 and browsing using a browse overlay window. The browsed-to selection may then be automatically attached to the form 100 and even e.g. represented in the field 112 as a local storage medium path for the file. Thus, the preconfigured user profile may be subsequently provided to the form provider along with the form 100 (e.g. as an attachment, and/or as information entered to the form).

In addition to the foregoing, the portion 114 may also include a create selector element 118 selectable to e.g. cause an overlay window to be presented for creating a profile such as the preconfigured profile described above or otherwise presenting various fields in the overlay window for entry of data to create a profile for a user of the CE device. Also in addition to or in lieu of the foregoing, the portion 114 may include a social networking selector element 120. The social networking selector element 120 may be selectable to do one or more of the following: Provide social networking login information for one or more accounts for one or more users and/or other identifying information for a social networking account via an overlay window overlaid over the form 100 to then be entered into the form 100 (e.g. in the field 112) for subsequent access by the provider of the form 100 for use of corresponding social networking profile and/or account information from the social networking account in accordance with present principles (e.g. determining AV content likes and dislikes of the user), and/or for use to automatically without further user input create a preconfigured profile as described above that includes information derived from the social networking account.

Still in reference to FIG. 4, beneath the portion 114 is a history portion 122 including a field 124 with pre-entered (e.g. automatically by the CE device prior) history information for e.g. channels and/or AV contents previously presented on the present CE device (and/or another CE device on the network) that may be e.g. editable by a user by providing input to the field 124 and changing the information using e.g. a virtual keyboard also presented on a touch enabled display screen presenting the form 100. Beneath the portion 122 may be a location portion 126 including one or more fields in which location information (e.g. for the present CE device) may be entered. Thus, the portion 126 includes a zip code field 128 for zip code information (and is accompanied by a change selector element 130 for changing e.g. a zip code predetermined by the CE device and initially indicated in the field 128 when the form 100 is first presented), a state field 132 for state information (and is accompanied by a change selector element 134 for changing e.g. a state predetermined by the CE device and initially indicated in the field 132 when the form 100 is first presented), and a country field 136 for country information (and is accompanied by a change selector element 138 for changing e.g. a country predetermined by the CE device and initially indicated in the field 136 when the form 100 is first presented). Though not shown, note that a city and/or town field may be included in the portion 126 as well.

Now in reference to a likes, dislikes, and/or preferred content portion 140 beneath the portion 126, it includes a likes field 142 for e.g. particular contents and/or content types or classes which the user likes as may be automatically determined by the present CE device based on e.g. a content viewing history and/or a user emotion history of emotions derived from facial expressions of one or more users when previously watching content of a certain type or class, it being noted that such emotion history may be stored e.g. in a set top box, the present CE device, and/or a cloud storage area in accordance with present principles. Beneath the likes field 142 is an add/delete selector element 144 selectable for editing the information (e.g. adding or deleting at least a portion thereof) in the field 142. Also included in the portion 140 is a dislikes field 146 for e.g. particular contents and/or content types or classes which the user dislikes as may be automatically determined by the present CE device based on e.g. a content viewing history and/or a user emotion history of emotions as described immediately above. Beneath the dislikes field 146 is an add/delete selector element 148 selectable for editing the information (e.g. adding or deleting at least a portion thereof) in the field 146.

Still another portion may be included in the form 100, such as a device purchasing information portion 150. The portion 150 includes a location field 152 for a purchase location at which the present CE device was purchased (and/or purchase price, purchase date, etc.), as well as a change selector element 154 selectable to e.g. cause an overlay window to be presented on the form 100 for changing the information entered (e.g. automatically by the CE device) into the field 152, though it is to be understood that the field 152 (and indeed many of the fields described herein) may itself be selectable to add, delete, and/or change information in the field 152 directly at the field 152 using e.g. a virtual keyboard rather than being presented with an overlay window for doing so. Regardless, the portion 150 also includes at least one location field 156 for a purchase location at which at least one other CE device (e.g. connected to same network as the present CE device and/or otherwise associated with a user of the present CE device) was purchased, as well as a change selector element 158 or changing the information entered into field 156.

Furthermore, note that although not shown in FIG. 4, in some embodiments the form 100 may include one or more fields for entry of demographic information pertaining to one or more users of the CE device(s) as well. The demographic information fields may be for entry of demographic information pertaining to e.g. age, race, gender, religion, level of education, yearly income, etc.

Concluding the description of FIG. 4, a submit selector element 160 is shown that is understood to be selectable by a user to e.g. automatically without further user input responsive thereto cause the information entered to the form 100 and/or the at least partially completed form itself to be provided to the provider of the form, a provider of AV content, a third party such as an advertiser, and/or a cloud storage area for access by e.g. the user of the present CE device and/or a provider of the form or AV content.

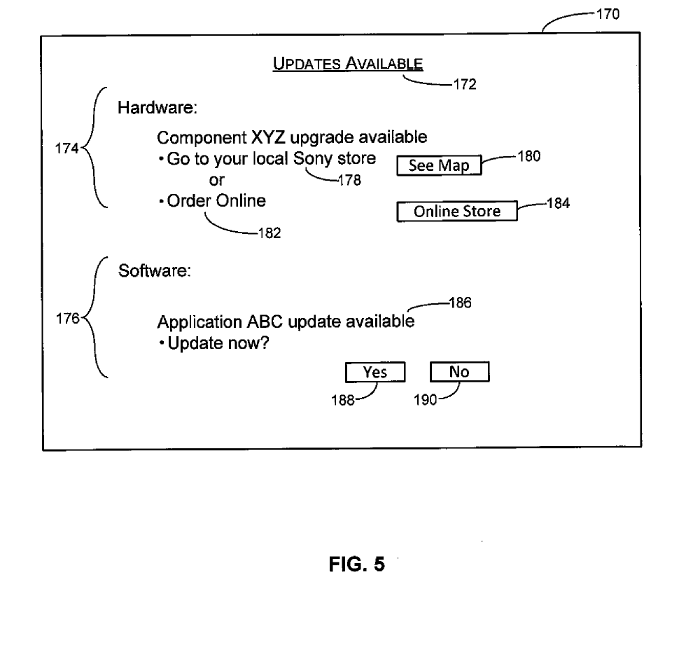

Continuing the detailed description in reference to FIG. 5, an exemplary hardware and/or software update notification/UI 170 (e.g. as described in reference to FIG. 3) that is presentable on a CE device in accordance with present principles is shown. The UI 170 thus includes a title 172 indicating that one or more updates are available. The UI 170 also includes a first portion 174 pertaining to hardware and/or physical device updates and/or upgrades for one or more devices, and a second portion 176 pertaining to software updates for one or more devices.

Beginning first with the portion 174, it includes information such as at least one indication that one or more hardware and/or physical device updates are available for one or more pieces of hardware and/or devices that were e.g. indicated in a form in accordance with present principles as being associated with a user, a network in a personal residence, etc. The portion 174 thus includes an indication 178 that the update may be obtained at a physical location such as a (e.g. walk-in) retail store, along with a corresponding map selector element 180 selectable to automatically without further user input responsive thereto present a map at least of e.g. a local area and indicating retail stores vending the update, and/or an area indicating the closest retail store for purchasing the update. The portion 174 also includes an indication 182 that in some embodiments indicates the update may be purchased online via e.g. an online and/or electronic retail store, which may be presented automatically without further user input responsive to selection of an online store selector element 184 associated with one or more online stores from which the update may be purchased. As an example of an update that may be purchased, e.g. an add-on box engageable with a television through e.g. a USB port may be made available after purchasing the television to provide additional functionality to the television. As another example, a newer model of television in the same line of televisions as the purchased one may be another update/upgrade indicated to a user and made available for purchasing in accordance with present principles.

Describing the portion 176, it includes information such as at least one indication that one or more software updates are available for one or more CE devices that were e.g. indicated in a form in accordance with present principles as being associated with a user, a network in a personal residence, etc. The portion 176 thus includes an indication 186 that an update is available, such as e.g. a operating system update, a device software update and/or upgrade, an application update for an e.g. “app” downloaded to the device, etc. The portion 176 also prompts the user for whether to download the update(s), and accordingly the portion 176 includes a yes selector element 188 selectable by a user to respond in the affirmative and hence e.g. automatically without further user input download the update, and a no selector element 190 for declining to do so. Based on the foregoing description of FIG. 5, it is to be further understood that such a notification may be and/or include an advertisement from the manufacturer of the CE device(s) for which the update is available.

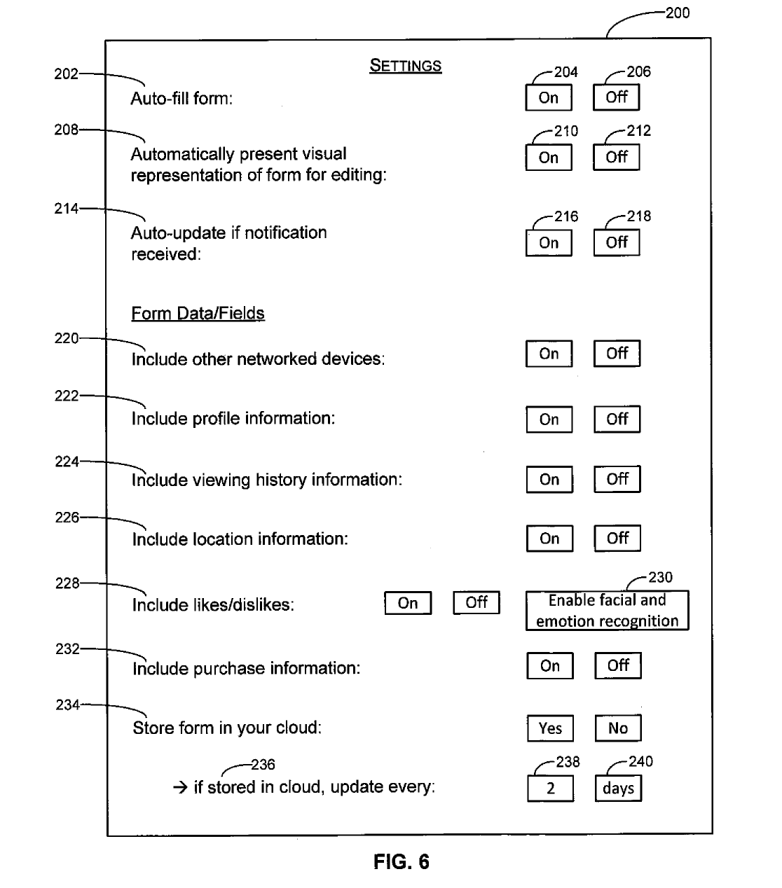

Continuing now in reference to FIG. 6, it shows an example settings user interface (UI) 200 presentable on a CE device for configuring e.g. form fields and/or automatic form information input by a CE device in accordance with present principles. The UI 200 includes a first setting 202 for whether or not to permit automatic entry of data and/or information to a form by a CE device in accordance with present principles, and thus the setting 202 may pertain to e.g. enabling or disabling altogether the entrance such form information and making it available to e.g. a content provider. Thus, an on selector element 204 for enabling auto-fill of one or more fields of a form is provided, as is a no selector element 206 for disabling auto-fill of such a form. A second setting 208 is also shown which pertains to whether or not to automatically present a visual representation of a form (e.g. when received and/or after being auto-filled by the CE device itself) for editing, and thus an on selector element 210 and off selector element 212 for respectively enabling or disabling such automatic presentation are provided. Yet a third selector element 214 is shown for whether to automatically e.g. download and update software in accordance with present principles if e.g. an update is pushable to the CE device and/or a notification of an update is provided thereto, and hence an on selector element 216 for configuring the CE device to automatically download an update is shown along with an off selector element 218 for configuring the CE device to not automatically download such updates.

The settings UI 200 also includes one or more settings pertaining to particular types of data and/or information for entry into respective, corresponding particular form fields in accordance with present principles. It is to be understood that each of these settings to be shortly described are as shown in FIG. 6 each accompanied by on and off selector elements for configuring the CE device to respectively enable or disable the particular setting to which the elements pertain. Thus, in accordance with present principles the UI 200 includes a setting 220 for enabling or disabling automatic entry of data and/or information pertaining to other (e.g. networked) CE devices, a setting 222 for enabling or disabling automatic entry of data and/or information pertaining to a user profile, a setting 224 for enabling or disabling automatic entry of data and/or information pertaining to content and/or channel viewing history information, a setting 226 for enabling or disabling automatic entry of data and/or information pertaining to location information, a setting 228 for enabling or disabling automatic entry of data and/or information pertaining to likes, dislikes, and/or preferred content for a user(s) (note that the setting 228 includes a selector element 230 associated therewith that is selectable to e.g. enable or disable a setting on the CE device for using facial and/or emotion recognition using at least one image from a CE device camera for determining likes and dislikes of content), a setting 232 for enabling or disabling automatic entry of data and/or information pertaining to CE device purchasing information, and a setting 234 for enabling or disabling automatic storing of the form and/or data and/or information entered thereto in a (e.g. predefined) cloud storage area associated with the user and/or network.

Note that beneath the setting 234 is another setting 236 for whether or not to automatically without user input update the form and/or data/information for the form as stored in the cloud if and when the setting 234 has been enabled. Thus, the setting 236 includes a field 238 for a user to provide numerical input and a field 240 for a user to provide input of a time parameter for how often such an update should occur. Thus, the field 240 may indicate that the update should occur every X e.g. seconds, hours, days, weeks, months, years, etc. per the number e.g. specified in field 238. For example, the update may occur every two days as shown in FIG. 6.

Without reference to any particular figure, it is to be understood that device information for “other devices” as described above may be determined by a CE device executing the logic disclosed herein and/or presenting the UIs, prompts, notifications, etc. disclosed herein based on information pertaining to the “other” networked device gathered by the CE device using universal plug and play (UPnP) communication with the other devices or other device communications and/or communication protocols.

Still without reference to any particular figure, it is to be understood that present principles may be applied even when e.g. a cable or satellite head end erects a virtual “brick wall” by only passing on audio and/or video content and not metadata from e.g. a network broadcaster or other content provider that provided content to the head end to then be provided by the head end to one or more CE devices. This may be accomplished by e.g. watermarking and/or fingerprinting audio, video, or both audio and video of the AV content with the tag disclosed herein indicating the location of a form in accordance with present principles. “Watermarking” may entail e.g. spreading such data (e.g. the tag data and/or location information for the form) throughout the audio, video, or both audio and video. “Fingerprinting” may entail e.g. including such data in a header for the content such as an IP header. But regardless of whether such a tag is provided via watermark or fingerprint, it is to be understood that once received by a CE device the CE device may e.g. automatically access the location for entering data to the form using the location information from the tag.

Put another way, the tag can be received as part of a watermark and/or fingerprint in audio and/or video of AV content from a content provider, The CE device receiving the tag may then e.g. using UPnP communication determine other devices in communication therewith and may provide this reading back to the content provider and/or a third party such as a manufacturer of the device discovered using UPnP. Thus, although present principles recognize that in some embodiments the form described herein may be completed and provided in its entirety back to the form's provider using the same communication medium (e.g. satellite communication), sometimes this is not possible such as when e.g. cable providers/head ends erect a “brick wall” not permitting transmission of metadata back to the content provider and that in such instances a tag included in a watermark or fingerprint may be received to then send back form information and/or the form with information included therein over e.g. a “back-end” IP channel (or otherwise transmit the information via the Internet). Note, however, that in addition to or in lieu of the foregoing, an out of band channel of the cable provider may also be used to transmit the form information and/or at least partially completed form.

Based on the foregoing, it may now be appreciated that systems, methods, and devices are provided to inform a content provider of targets of opportunity in a person's personal eco-system, where tags are created for tracking user profiles and available devices by using the UPnP communication and user behavior platform profiles e.g. stored in the cloud, where the “implicit” form indicated (and even provided in) the tag as being empty is filled/completed, and furthermore the implicit form may be edited via a visual representation of the form presented on a display of a CE device.

Accordingly, present principles provide content providers with a way to get more in tune with customers and what the customer wants by determining e.g. in real time which content is being viewed, and combine that information with other user information and/or profiles to tailor advertising for them for e.g. updates to their hardware and/or services. For instance, a manufacturer employing present principles may offer next generation product and/or a more useful experience by knowing user habits and personal interests.

As indicated above, this may be provided by content providers adding a tag in the video/audio/metadata stream which points to a form that a device such as e.g. a television receiver can fill out and then transmit back to the content provider or to the users' cloud storage. The form may include items like available devices in the home, user zip code, profile, likes and dislikes, etc. Content providers may then access that cloud information or the direct feedback information to learn how to filter advertising to that user, supply information of available device upgrades seen in the home (via UPnP reading of other devices) or still other services. This enables opportunities for providers to better interact with their customers, know their habits and desires, generate revenue, and heighten customer satisfaction.

As an example, a content provider and/or manufacturer having received back a completed form that was provided by it may determine that a particular user has a 4K definition television. Using this information, an advertisement may be provided by to the user via one or more of the user's CE devices offering 4K content for purchasing.

As but one last example, assume a user's e.g. social networking profile indicates they are interested in purchasing a new car and/or like vehicles manufacturer by Chevrolet. This information may be entered into a form in accordance with present principles and then provided by to the content provider and/or a third party advertiser, which may then transmit advertisements to the user pertaining to Chevrolet vehicles currently being sold in the user's area.

While the particular FILLABLE FORM FOR PROVIDING AND RECEIVING CUSTOMIZED AUDIO VIDEO CONTENT is herein shown and described in detail, it is to be understood that the subject matter which is encompassed by the present invention is limited only by the claims.

What is claimed is:

1. A device comprising:
at least one computer readable storage medium bearing instructions executable by a processor;
at least one processor configured for accessing the computer readable storage medium to execute the instructions to configure the processor for:
receiving an audio video (AV) content stream from a content source;
receiving a form with the AV content stream, the form including plural information fields, the plural information fields including at least an available devices field and a location field;
inserting information pertaining to plural networked devices in the available devices field and inserting at least a location of the networked devices into the location field; and
making the form with the inserted information accessible to the content source.

2. The device of claim 1, wherein the form is made accessible to the content source by storing the form with the inserted information in a cloud storage area accessible to the content source.

3. The device of claim 1, wherein the form is made accessible to the content source by transmitting the form with the inserted information to the content source.

4. device of claim 1, wherein the device is a consumer electronics (CE) device and at least a first networked device of the networked devices is the CE device.

5. The device of claim 4, wherein information pertaining to a second networked device of the networked devices is inserted into the available devices field, the second networked device information being determined by the first networked device based on information pertaining to the second networked device gathered by the first networked device using universal plug and play (UPnP) communication.

6. The device of claim 1, wherein the information is inserted automatically without user input into the plural information fields responsive to receiving the form.

7. The device of claim 1, wherein the location of the networked devices is a zip code encompassing the networked devices.

8. The device of claim 1, wherein the form further includes a profile field configured for insertion of profile information pertaining to a user of the device.

9. The device of claim 8, wherein the instructions configure the processor for inserting the profile information into the profile field.

10. The device of claim 9, wherein the profile information is determined by the device at least in part based on social networking account information of the user, the social networking account information being accessible to the device.

11. The device of claim 9, wherein the profile information includes information pertaining to the user's AV content observance history, the information pertaining to the AV content observance history being accessible to the device.

12. The device of claim 9, wherein the profile information includes demographic information pertaining to the user, the demographic information being determined by the device based on an AV content history of AV content presented on the device.

13. The device of claim 1, wherein the form further includes a likes and dislikes field configured for insertion of information pertaining to AV content likes and dislikes of a user of the device.

14. The device of claim 13, wherein the instructions configure the processor for inserting the information pertaining to AV content likes and dislikes of the user, the information pertaining to the likes and dislikes of the user being determined based on user input received by the device of respective likes and dislikes of AV contents.

15. A server, comprising:
at least one computer readable storage medium bearing instructions executable by a processor;
at least one processor configured for accessing the computer readable storage medium to execute the instructions to configure the processor for:
providing an instrument to a first consumer electronics (CE) device configured for entrance of data by the first CE device, the instrument including at least one area in which data is enterable by a CE device, the at least one area including an area configured for entrance of data pertaining to device identification information for at least one CE device;
receiving the instrument back from the first CE device with device identification information included in the instrument for the at least one CE device, the device identification information being entered at the first CE device; and
responsive to a determination that the device identification information pertains to a CE device for which an update is available, providing a notification to the first CE device that the update is available.

16. The server of claim 15, wherein the notification is an advertisement from the manufacturer of the CE device for which the update is available.

17. The server of claim 15, wherein the instrument is provided to the first CE device in metadata of an audio video (AV) content provided with the AV content to the first CE device.

18. The server of claim 17, wherein the metadata is an AV content tag.

19. A method, comprising:
providing a first audio video (AV) content to at least a first CE device along with a metadata tag for the first AV content, the metadata tag including location information for a form accessible by the first CE device, the form configured for entrance of data by the first CE device;
accessing data entered by the first CE device to the form; and
based at least in part on the data, providing a second AV content to the first CE device.

20. The method of claim 19, wherein the first CE device is a set top box, wherein the form is stored at a location accessible to the first CE device over the Internet, and wherein the form includes plural data input fields, the plural data input fields including at least an available devices field for entering identification data for other CE devices networked with the first CE device, a location field for entering location data for the other CE devices, and a user field for entering demographic information of the user of the first CE device.
